(19) United States
(12) Patent Application Publication
(10) Pub. No.: US 2017/0330073 A1
(43) Pub. Date: Nov. 16, 2017

(54) INFORMATION PROCESSING DEVICE FOR ASSET MANAGEMENT AND TRADING

(71) Applicant: ORE Tech Ltd., Ramat Gan (IL)

(72) Inventor: Shmuel UR, Shorashim (IL)

(21) Appl. No.: 15/588,735

(22) Filed: May 8, 2017

Related U.S. Application Data
(60) Provisional application No. 62/334,455, filed on May 11, 2016.
(60) Provisional application No. 62/427,826, filed on Nov. 30, 2016.

(51) Int. Cl. G06N 3/08; G06Q 40/04

(52) U.S. Cl. CPC G06N 3/08; G06Q 40/04

(57) ABSTRACT

An information processing device for processing trade data for asset management and trading is disclosed. The information processing device includes the one or more processors configured to determine price of a commodity indicated by the trade data. The price being valid in an event the one or more processors receive a user input indicating authorization of a user to revoke a deal of the commodity within predetermined time duration. The one or more processors are configured to determine the price by using a neural network, the neural network being trained by the one or more processors based on one or more data sets corresponding to the commodity.

### CROSS REFERENCE TO RELATED APPLICATION

The present application claims the priority benefits of U.S. Provisional Application No. 62/334,455, filed on May 11, 2016, titled “Easy Cancellation Option (“ECO”)”, and U.S. Provisional Application No. 62/427,826, filed on Nov. 30, 2016, titled “Embedded Cancellation Option (“ECO”), which are incorporated herein by reference in their entirety.

### FIELD OF INVENTION

The present invention relates to asset management and trading, more particularly, the present invention relates to an information processing device and a method thereof, for asset management and trading.

### BACKGROUND OF THE INVENTION

The advent of computerized trading and other forms of advanced information processing in recent years has created a new family of global investment products, such as commodity options; real estate and currency funds; and other derivative instruments. Computers and other similar information processing devices, in general, are very adept at dealing with large amounts of numerical information, and are therefore configured to handle dealing of volatile commodities, such as stocks in a stock market, plane ticket prices, mortgage rate, EC2 instances, Digital Media and the like.

Conventionally, in order to enable asset management and trading, conventional information processing devices determine price of a commodity which a user intends to purchase. As very well-known and also in accordance with laws of many countries, for volatile commodities once the user purchases a commodity, the conventional information processing devices do not provide an option of revoking the deal of the commodity. Due to denial of cancellation or revoking of the deal once the purchase of the deal is done through the conventional information processing devices, users have to face inconvenience and bear financial loss. Further, in many instances the conventional information processing device fails to provide correct price information for a deal of the commodity, due to lack of required processing resources. The conventional information processing devices lack ability to formalize unclassified information and further lack ability to make forecast based on historical information or other such information stored therein.

Hence, there is a need to alleviate aforementioned limitations and accordingly, it would be desirable for an improved information processing device for asset management and trading.

### SUMMARY OF THE INVENTION

The present invention has been made in the view of the above problems, and in one aspect of the present invention there is provided an information processing device for processing trade data for asset management and trading. The information processing device includes the one or more processors configured to determine price of a commodity indicated by the trade data. The price being valid in an event the one or more processors receive a user input indicating authorization of a user to revoke a deal of the commodity within predetermined time duration. The one or more processors are configured to determine the price by using a neural network, the neural network being trained by the one or more processors based on one or more data sets corresponding to the commodity.

In another aspect of the present invention, there is provided a method for processing trade data for asset management and trading. The method, in an information processing device, includes determining price of a commodity indicated by the trade data. The price being valid in an event the information processing device receives a user input indicating authorization of a user to revoke a deal of the commodity within predetermined time duration. The price is determined by using a neural network, the neural network being trained by the information processing device based on one or more data sets corresponding to the commodity.

In another aspect of the present invention, there is provided a storage media storing a program executed by the computer, wherein the program includes a determining step to determine price of a commodity indicated by the trade data. The price being valid in an event the information processing device receives a user input indicating authorization of a user to revoke a deal of the commodity within predetermined time duration. The price is determined by using a neural network, the neural network being trained by the information processing device based on one or more data sets corresponding to the commodity.

Those skilled in the art will appreciate the advantages and superior features of the invention together with other important aspects thereof on reading the detailed description that follows in conjunction with the drawings.

### BRIEF DESCRIPTION OF DRAWINGS

Other objects, features, and advantages of the invention will be apparent from the following description when read with reference to the accompanying drawings. In the drawings, wherein like reference numerals denote corresponding parts throughout the several views:

FIG. 1 is a schematic view of system for asset management and trading, in accordance with an embodiment of the present invention.

FIG. 2 is a block diagram of an information processing device shown in FIG. 1.

FIG. 3 is a flow chart illustrating a method for processing trade data for asset management and trading, in accordance with another embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

The invention relates to an information processing device which enables asset management and trading. The information processing device processes trade data to enable aforementioned asset management and trading. The information processing device determines price of a commodity to help user of the information processing device in carrying out stock management. Herein this disclosure, the aforementioned stock management or the trading or the asset management is described with reference to an act of cancelling or revoking of a deal by the user of the information processing device. However, the stock management or the trading or the asset management may also refer to investment trading, creating secure portfolios, evaluating shares for investment, and the like. The information processing device may be a standalone electronic device with capabilities to carry out complex calculations and analysis. In an embodiment, the asset management and trading may be facilitated by a method implemented by a centralized computer (server). Specifically, one or more information processing devices may be in communication with the server via cloud to enable the information processing device to provide real time determination of prices of commodities for enabling efficient asset management and trading.

In an embodiment, a user of the information processing device of the present invention may refer to a buyer of a commodity. In another embodiment, the user may also refer to a seller of the commodity or a third party service provider to the buyer and seller of the commodity.

For purposes of the description as set forth below, a process, method, routine, or sub-routine is generally considered to be a sequence of computer-executed steps leading to a desired result. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for computer operations and that these terms are merely conventional labels applied to physical quantities that exist within and during operation of the computer.

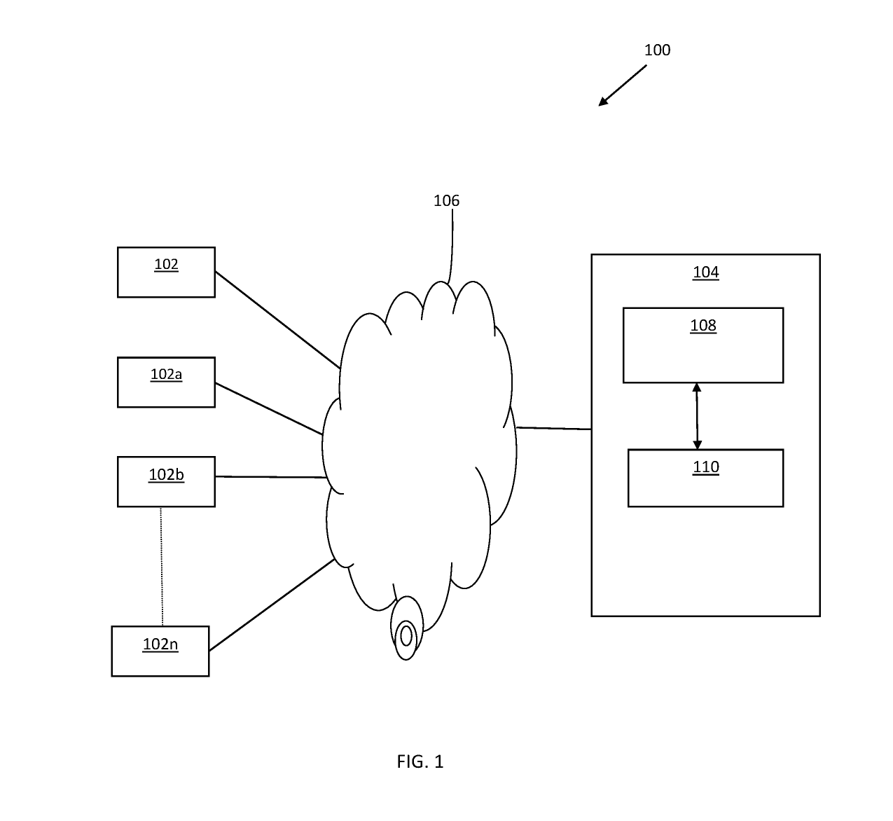

FIG. 1 is a schematic view of a client-server architecture utilized by a system for asset management and trading, within an embodiment of the present invention. Referring to FIG. 1, the system 100 includes one or more electronic devices, specifically information processing devices, 102, 102a, 102b . . . 102n, a computer 104, a communication network 106. The computer 104 includes a central processing unit (CPU) 108 and a data storage 110. The information processing devices 102, 102a, 102b . . . 102n may be communicably connected to the computer 104 through the communication network 106.

In an embodiment, the computer 104 may represent a server for processing and storing trade data which is related to trading and asset management. Herein this disclosure, the trade data may comprise information about a volatile commodity available for trading, such as historical actual prices, historical commercial prices, periodic prices, or any other such price/value related data. In accordance with an embodiment of the present disclosure, the central processing unit 108 processes data received from the information processing devices 102, 102a, 102b . . . 102n to facilitate asset management and trading. In another embodiment, the information processing devices 102, 102a, 102b . . . 102n may only receive trade data from the central processing unit 108 and further may process the received trade data for facilitating asset management and trading. The computer 104 utilizes the data storage 110 to store data received from the information processing devices 102, 102a, 102b . . . 102n and other data related to commodity pricing. The central processing unit 108 extracts data from the data storage 110 to generate trade data which is sent to the one or more information processing devices 102, 102a, 102b . . . 102n.

In an embodiment, the information processing devices 102, 102a, 102b . . . 102n may be connected to the computer 104 through a wireless network such as Global System for Mobile Communication (GSM), Code Division Multiple Access (CDMA), 2G, 3G, and 4G.

In an embodiment, the information processing devices 102, 102a, 102b . . . 102n may be connected to the computer 104 through a wired connection which may include dedicate lines that may be part of a local area network (LAN) or a wide area network (WAN).

In an embodiment, the information processing devices 102, 102a, 102b . . . 102n may communicate with the computer 104 through Bluetooth communication, infra-red communication, WI-FI and Near Field Communication (NFC).

In an embodiment, the communication between the information processing devices 102, 102a, 102b . . . 102n and the computer 104 may be an encrypted communication to provide enhanced security in transaction of data.

In an embodiment, each of the information processing devices 102, 102a, 102b . . . 102n may be a shareable portable digital device including Personal Digital Assistants (PAD), notebook computers, laptops and communication devices such as mobile phones, satellite phones and tablets.

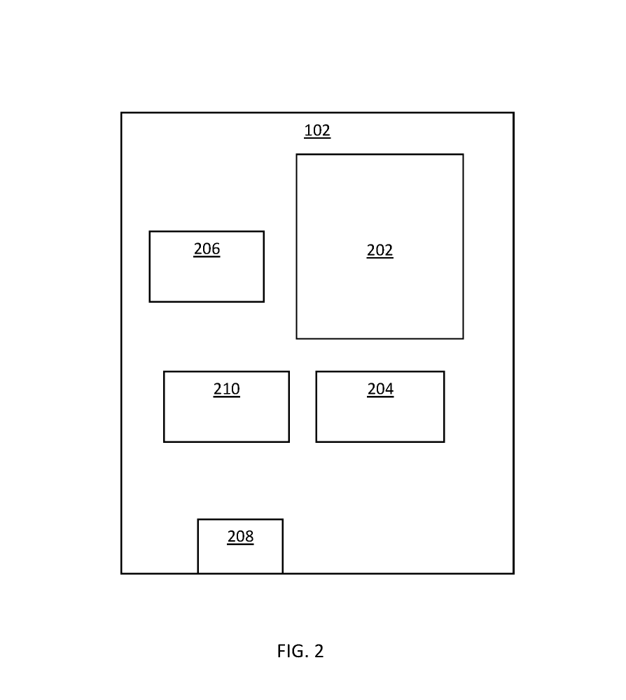

FIG. 2 is a block diagram of the information processing device 102 as shown in FIG. 1. For the purpose of mere illustration, the following description is provided with respect to a single information processing device, however it may not be construed to only one information processing device as all the information processing devices shown in FIG. 1 comprising same architecture and configuration. FIG. 2 is described in conjunction with FIG. 1. As shown in FIG. 2, the information processing device 102 may include one or more processors, such as a processor 202, one or more memory, such as memory 204, a transceiver 206, one or more I/O interfaces, such as an I/O interface 208 and a display 210.

The processor 202 may be communicably coupled with the transceiver 206 to receive signals from the server, such as the computer 104. Further, the transceiver 206 may be configured to transmit signals generated by the processor 102. The processor 102 is in communication with the memory 204, wherein the memory 204 includes program modules such as routines, programs, objects, components, data structures and the like, which perform particular tasks to be executed by the processor 202. The information processing device 102 may be connected to other information processing devices by using the I/O interface 208. The display 210 may be utilized to receive inputs from a user using the information processing device 102. The I/O interfaces 116 may include a variety of software and hardware interfaces, for instance, interface for peripheral device(s) such as a keyboard, a mouse, a scanner, an external memory, a printer and the like.

In an embodiment, the processor 202 may include neural network-based algorithms that are effective in several applications including: diagnosis or pattern recognition, e.g. speech and image processing, because the neural network algorithm is capable of adjusting to patterns in data. Herein, Neural networks may deduce relationships between the different data variables, e.g. estimation or prediction applications even when difficulties exist in completely specifying the rules for a model. Further, Neural networks may assess interrelationships between the factors and predict outcomes with significant accuracy. In an aspect of the present invention, a neural network may process large amounts of data in real-time. Once the training set for the neural network is developed, the learning algorithm trains the neural network by creating a network of associations between possible aspects of input and response. In another aspect of the present invention, the neural network may be scaled and reused for other problem domains different from asset management and trading. In one embodiment, the neural network may refer to an artificial neural network or any other learning algorithms such as clustering algorithms, deep learning algorithms, and the like.

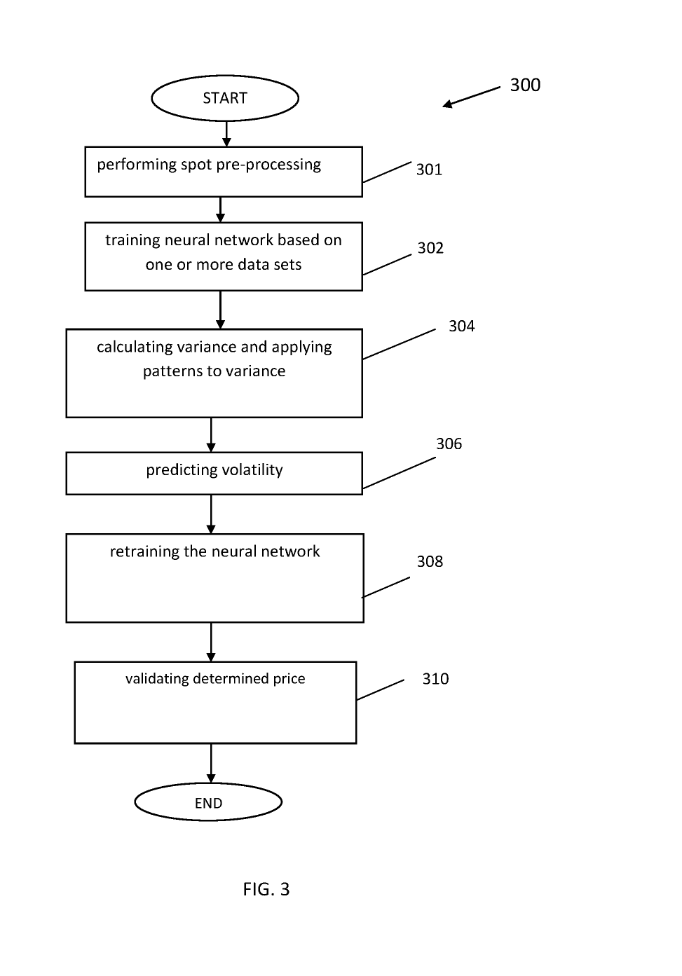

FIG. 3 is a flow chart illustrating a method for processing trade data for asset management and trading. As shown in FIG. 3, the flow chart 300 illustrates exemplary steps of processing the trade data. The processor 202 determines price of a commodity which is indicated by the trade data. In an exemplary embodiment, the commodity refers to a volatile commodity, such as stocks in a stock market, plane ticket prices, mortgage rate, EC2 (amazon) instances, Digital Media, or other such commodities whose price change rapidly over time. As well known in the art, once a user purchases a deal of a volatile commodity, the purchased deal cannot be revoked by the user. In order to enable the user to cancel or revoke the purchased deal of the volatile commodity, a cancellation option has to be provided to the user. The cancellation option may be provided to the user if an option for the cancellation provision would have been opted by the user. For example, if at a time of purchasing a deal for a volatile commodity, if a user has opted for insurance, then the insurance would enable the user to cancel or revoke the deal by providing certain conditions under which the deal can be cancelled or revoked. Further, few lead times are suggested to the user, each lead time associated with the price. The price is monotonic, therefore larger the lead time and higher the price. Herein this disclosure the lead time refers to but not limited to a duration during which the insurance may be used. Furthermore, for a given price the user may pay for the insurance, the lead time corresponding to the paid price may be determined, wherein more the price paid and higher the lead time. The price for the insurance is calculated for a given lead time that the user is interested in. In an embodiment, conditional insurance may be provided to the user, wherein either insurance needs to be used by the user within predetermined time duration or the insurance automatically gets activated, once an exposure passes a certain level. Herein this disclosure, the exposure refers to but not limited to an amount the insurance is for or a cost of the commodity.

In an embodiment, at the time of purchasing the deal of the volatile commodity, price of the commodity may include insurance which activates a cancellation option to the user. In another embodiment, the price of the volatile commodity may be exclusive of any such cancellation option and has to be purchased separately by a user. The information processing device of the present disclosure automatically determines the price of the volatile commodity so that the user can be given a cancellation option to revoke the purchased deal. The cancellation option may enable the user to cancel or revoke the deal within a predetermined duration such as predetermined number of days from the date of purchasing or a predetermined number of months from the date of purchasing. In an embodiment, a user is presented with the cancellation option and in an event the user opts for the cancellation option, a price of the commodity is determined. Therefore, the information processing device of the present disclosure determines the price of the commodity when the information processing device receives a user input indicating authorization of the user to revoke the purchased deal. Herein, the authorization refers to the determination by the information processing device that the user has opted for cancellation option or a seller of the commodity has embedded the cancellation option in the given deal of the commodity. At step 301, the processor 202 of the information processing device 102 may perform Spot pre-processing which includes data validation and filtering, sampling of data, and control of Spot Window shape and width.

At step 302, the processor 202 of the information processing device 102 may train the neural network (not shown in figures) based on one or more data sets. The one or more data sets correspond to the commodity being indicated by the trade data. The training of the neural network is performed by performing one or more steps of data filtering, data validation, data sampling, and/or data sorting on the data sets by the processor 202. The data sets correspond to one or more of historical actual prices, historical commercial prices, periodic prices, and/or aperiodic prices, of the commodity. In an embodiment, the data sets may further correspond to seasonality data such as daily, monthly, and the like; or commercial historical data such as turn over per price; or any other data that would affect the price.

At step 304, the processor 202 may perform variance calculation, wherein the processor 202 may apply intraday periodic and aperiodic patterns to the variance. Further, at step 306, the processor 202 may predict volatility related to the price of the commodity by using the neural network and performs validation of the determined price.

At step 308, the processor 202 may retrain the neural network to adjust the determined price of the commodity to keep the asset management and the trading profitable. The processor 202 may retrain the neural network based on a feedback mechanism which includes adjusting the price depending on performance estimation in real time. The performance estimation in real time includes a comparison between stored historical volatility data and the predicted volatility. The stored historical volatility and the volatility are predicted for same time intervals.

In accordance with an embodiment, as indicated by step 310, the processor 202 may validate the determined price by estimating volume pricing for different strikes for the commodity. Further, the processor 202 may estimate “at the money” (ATM) volatility for a plurality of time intervals of same duration. The processor 202 may generate a message indicating avoidance of trading of the commodity in an event a difference between each of the plurality of time intervals exceeds a predetermined threshold value.

In an embodiment, the processor 202 executes instructions in a logical way as described herein below in the Algorithm to carry out the processing of trade data for asset management and trading.

Firstly, for each update in a Spot Feed, add new Spot Rate Return to a list of Spot Rate Returns for Variance Sample calculation. Each Spot Rate Return holds a reference to a Start and End Spot rates, from which the return will be calculated. Each Spot Rate contains “Spot Rate GUID”, “Pair Symbol”, “Bid”, “Ask”, “Provider ID”, “Creation Date” (timestamp by the clock of a third party Spot provider server, from which the Spot is received), and “Received Date” (timestamp by the clock of Quotes server, which received the Spot). In every 10 seconds (configurable Sampling Interval), single Variance Sample is calculated and data from Spot Rate Returns list is aggregated. Before calculation starts, all elements of the list containing both Start and End spot rates are moved to a separate list, on which the filtering and actual calculation is performed. If there is a last element in the list which does not have End spot rate, it is not moved, and becomes first Spot Rate Return element of the list for the next sample period.

Further, returns with a duration (difference between Start and End Spot Received Dates) larger than 5000 ms (configurable Maximum Return Time Interval Limit) and with an absolute value of Log Return (ln(EndSpotRate.Mid/StartSpotRate.Mid)) larger than 0.2 (configurable Max Log Return Limit) are filtered out from the Spot Rate Returns list copy. Further, “Pair Symbol”, “Start Sample Timestamp”, “End Sample Timestamp”, “Sum of squared Spot Log Returns for all the elements of the list” (Sum(ln(EndSpotRate.Mid/StartSpotRate.Mid)̂2), “Number of Spot Rate Returns used for the calculation”, “Last Spot Rate Mid used for the calculation”, “Average Spot Rate Mid used for the calculation”, “Min Spot Rate Mid used for the calculation”, “Max Spot Rate Mid used for the calculation”, “Max Return Time Interval Limit used for the sample filtering”, “Max Log Return Limit used for the sample filtering”, “Number of Spot Rate Returns excluded from the calculation by the filtering”, are calculated for each sample, based on the filtered Spot Rate Returns list copy.

The calculated Variance Sample is added to the list of Variance Samples, used for the next calculation steps. The Variance Sample list is maintained to keep no more than Maximum Variance Sample Count of elements. If the element count is getting above this limit, the oldest sample is removed from the list. Based on the Sampling Interval and the Maximum Variance Sample Count, the period of Spot history used for the calculation of Volatility is determined. Using projected future Variance Sample list, Volatility is calculated as SQRT (Sum of Squared Spot Log Returns/ToYearFraction(Max(End Sample Timestamp)−Min(Start Sample Timestamp))). The calculated Volatility and last Spot Rate from the past Variance Sample list is used to calculate the Price of the commodity as BlackScholesPrice (spot=last Spot Rate, strike=last Spot Rate, Interest Factor Domestic=1, Interest Factor Foreign=1, Volatility, ToYearFraction(ECO Expiration Period)). The price is returned as a factor, so that NonBasePremiumAmount=BlackScholesPrice*DealBaseAmount.

The parameters which are included in price record are “Pair Symbol”, “Price Timestamp—timestamp of the moment of the price calculation”, “Spot rate—Spot used for BlackScholes, “Volatility—Volatility used for Black Scholes”, Black Scholes Price, “First Sample Sequence”, and “Last Sample Sequence”.

### Preparation Stage

The input to the algorithm is historic data of the values of the commodity over time, commercial data, seasonality data and other required data before the insurance is requested. The first step is to calculate variety of values on the data. Sampling the rates refers to collecting all actual rates that were traded in the past Time Stamp.

### Creating an Option

To determine the price for lead time T, T is inserted into timestamp in the algorithm. The price is determined for a few durations depending on user request. The price is reduced if the amount of exposure is reduced. If the exposure is limited to E, the price is reduced. For a given duration T, the price will be smaller with limited exposure and for a given amount to duration will be larger with a limited exposure.

### Adding Cancellation Option to the Sale of a Commodity

The cancellation option (determined price of a commodity) may be embedded by a seller and may be part of the selling offer offered by the seller. The seller may opt for the cancellation option for itself with the buyer. Further, the cancellation option may be provided by a third party.

In one aspect of the present invention, the information processing apparatus may be constructed by installing a program recorded in a computer readable recording medium, such as a CD-ROM, a DVD-ROM or the like, in an all-purpose computer such as a PC (Personal Computer). The program includes instructions which when executed by the computer enables the computer to operate in accordance with the algorithm as described in aforementioned description.

As will be readily apparent to those skilled in the art, the present invention may easily be produced in other specific forms without departing from its essential characteristics. The present embodiments is, therefore, to be considered as merely illustrative and not restrictive, the scope of the invention being indicated by the claims rather than the foregoing description, and all changes which come within therefore intended to be embraced therein.

What is claimed is:

1. An information processing device configured to process trade data for asset management and trading, said information processing device comprising:
one or more processors configured to determine price of a commodity indicated by said trade data, said price being valid in an event the one or more processors receive a user input indicating authorization of a user to revoke a deal of said commodity within a predetermined time duration,
wherein said one or more processors are configured to determine said price by using a neural network, said neural network being trained by said one or more processors based on one or more data sets corresponding to said commodity.

2. The information processing device as claimed in claim 1, wherein said one or more processors are configured to train said neural network by performing one or more steps of data filtering, data validation, data sampling, and/or data sorting on said one or more data sets, wherein said one or more data sets correspond to spot prices of said commodity in an event said neural network is trained by said one or more processors.

3. The information processing device as claimed in claim 2, wherein said one or more data sets correspond to one or more of historical actual prices, historical commercial prices, periodic prices, and/or aperiodic prices, of said commodity.

4. The information processing device as claimed in claim 1, wherein said one or more processors are further configured to predict volatility related to said price of said commodity by using said neural network.

5. The information processing device as claimed in claim 4, wherein said one or more processors are further configured to retrain said neural network to adjust said determined price of said commodity to keep said asset management and said trading profitable.

6. The information processing device as claimed in claim 4, wherein said one or more processors are configured to retrain said neural network based on a feedback mechanism which comprises adjusting said price depending on performance estimation in real time.

7. The information processing device as claimed in claim 6, wherein said performance estimation in real time comprises comparison between stored historical volatility data and said predicted volatility, wherein said stored historical volatility and said volatility are predicted for same time intervals.

8. The information processing device as claimed in claim 6, wherein retraining of said neural network further comprises validating said price by estimating volume pricing for different strikes for said commodity.

9. The information processing device as claimed in claim 1, wherein said one or more processors are further configured to estimate at the money (ATM) volatility for a plurality of time intervals of same duration.

10. The information processing device as claimed in claim 9, wherein said one or more processors are further configured to generate a message indicating avoidance of trading of said commodity in an event a difference between each of said plurality of time intervals exceeds a predetermined threshold value.

11. A method for processing trade data for asset management and trading, said method comprising:
in an information processing device:
determining price of a commodity indicated by said trade data,
wherein said price being valid in an event the information processing device receives a user input indicating authorization of a user to revoke a deal of said commodity within a predetermined time duration, and
wherein said price is determined by using a neural network, said neural network being trained by said information processing device based on one or more data sets corresponding to said commodity.

12. A system for asset management and trading, said system comprising:
a client computer comprising one or more processors configured to:
receive trade data for said asset management and said trading; and
determine price of a commodity indicated by said trade data,
wherein said price being valid in an event the one or more processors receive a user input indicating authorization of a user to revoke a deal of said commodity within a predetermined time duration, and
wherein said one or more processors are configured to determine said price by using a neural network, said neural network being trained by said one or more processors based on one or more data sets corresponding to said commodity, and
a server configured to transmit said trade data to said client computer.
